(19) United States
(12) Patent Application Publication
(10) Pub. No.: US 2025/0232198 A1
(43) Pub. Date: Jul. 17, 2025

(54) SYSTEM AND METHOD FOR AUTOCORRECTING QUANTUM RANDOM NUMBERS GENERATION

(71) Applicant: HCL Technologies Limited, New Delhi (IN)

(72) Inventors: MRITYUNJAY GHOSH, Noida (IN); ABHINAV KHARE, London (GB); PRANAV KAUSHAL, Noida (IN); AMLAN CHAKARBARTI, Calcutta (IN)

(21) Appl. No.: 18/663,170

(22) Filed: May 14, 2024

(30) Foreign Application Priority Data
Nov. 6, 2023 (IN) 202311075762

(51) Int. Cl. G06N 10/20; G06N 10/80

(52) U.S. Cl. CPC G06N 10/20; G06N 10/80

(57) ABSTRACT

This disclosure relates to method and system for autocorrecting Quantum Random Numbers (QRNs) generation. The method includes receiving, by an auto-correcting Quantum circuit, a plurality of QRNs from a cloud-based quantum computer. Each of the plurality of QRNs includes one or more digits. The method further includes calculating, by a postprocessing unit, a uniformity value and a randomness value corresponding to the one or more digits of the plurality of QRNs based on a predefined threshold uniformity value and a predefined threshold randomness value. The method further includes modifying, by the postprocessing unit, one or more of the plurality of QRNs based on the uniformity value and the randomness value using an autocorrection algorithm to obtain a target uniformity value and a target randomness value.

### TECHNICAL FIELD

This disclosure relates generally to quantum information processing, and more particularly to method and system for autocorrecting Quantum Random Numbers (QRNs) generation.

### BACKGROUND

Randomness is an intrinsic feature in nature and acts as a valuable resource for a diverse range of applications ranging from cryptographic solutions to online gambling, from numerical simulation of biological and physical systems to Monte-Carlo simulation in statistical modelling. Characterizing random numbers algorithmically using mathematics as a generator element can accelerate predictability and data dependency among generated random numbers. Physical systems come as a solution for random number generation as it is free from algorithmic or procedural constraints, thus exhibiting unpredictability or randomness in the system. Quantum theory depicts the fundamental randomness of a quanta particle due to its tendency to be susceptible to natural fluctuations.

Randomness exhibited in classical mechanics stems from an ignorance of physical information associated with the measurement process of the outcome. In quantum mechanics, the randomness feature does not stem from any lack of physical information but the inherent indeterminacy in measurement. A superposed state in quantum is a linear combination of states existing simultaneously, there is nothing inherently quantum about it. What gives the quantum flavor of non-determinism to superposition is the fact of measuring the system. The remarkable difference between classical physics and quantum physics lies in the fact of the inability of initial state environment effects to explain the occurrence of a definite experimental outcome. The environment cannot choose from possibilities in the wavefunction as an environment is also described by the same quantum laws. This advantage of quantum theory can be prominently used for generation of pure uniformly distributed series of random numbers.

In computational science, a machine is devised to act deterministically with the help of an algorithm inbuilt in it. The random numbers generated under an algorithm in a machine is called Pseudo-Random Numbers (PRNs), But they can offer deterministic randomness only, which is completely predictable once its internal state is known. This nature of PRNs does not guarantee unpredictability or randomness all the time, if simulated for a longer period with huge data set, they are susceptible to convergence after a particular cycle, called a period. In security-sensitive applications, this kind of algorithmic approach using mathematical element is proven to be highly unacceptable, as with an increase in computational power, the pattern behind generated random numbers under Pseudo Random Number Generators (PRNGs) will become fully deterministic. When numbers are generated pseudo-randomly many sequences cannot occur. For example, if Alice generates a truly random sequence of 20 shifts, it is equivalent to a uniform selection form a stack of all possible sequence of shifts. This stack will contain 2620 pages, which is astronomical in size, exploring which might take more than 200 million years. Compared to this, if Alice generates a 20-digit pseudorandom sequence using a 4-digit pure random seed, this is equivalent to a uniform selection from 10,000 possible initial seeds. The generation of 10,000 different sequences is vanishingly small in a fraction of all possible sequences. When we move from random to pseudo-random shifts, there is a significant amount of shrinkage of key space into a much smaller seed space. So, for a pseudo-random sequence to be indistinguishable from a randomly generated sequence, it must be impractical for a computer to try all seeds and look for a match. Using advanced computing power, if random numbers generated using a PRNG and a TRNG are simulated over a longer period, PRNs will exhibit convergence through a pattern and lose their unpredictable nature.

Quantum Random Number Generators based on radioactive decay often exhibit potential challenges. Lack of isolation of radioactive source could stray cosmic rays, radiation from radium, thorium or other radioactive material in the earth's crust. Another genre of quantum random number generators is based on optical quantum sources. Optical QRNGs take their feed from the random nature of quantum measurement. A generic problem with optical QRNG is generation of anticorrelating neighboring bits. This occurs due to blunted sensitivity of the detector before full recovery from dead time. Variations in detection efficiency and coupling ratio can primarily cause experimental bias. Our proposed Quantum Random Number Generator uses non-deterministic quantum hardware n intrinsic source of quantum randomness and uses the feature of contextuality through quantum information processing. In a quantum random number generator, decoherence of quantum states with superconducting qubits might cause a potential hindrance in the uniformity of generated random bits. In order to reduce the biasing of quantum states to converge into a pure state deterministically, there is a need in the present state of art for techniques to ensure uniform statistical distribution and zero correlation among bits.

### SUMMARY

In one embodiment, a method for autocorrecting Quantum Random Numbers (QRNs) generation may be disclosed. In one example, the method may include receiving, by a postprocessing unit, a plurality of QRNs from a cloud-based quantum computer. Each of the plurality of QRNs may include one or more digits. The method may further include calculating, by the postprocessing unit, a uniformity value and a randomness value corresponding to one or more digits of the plurality of QRNs based on a predefined threshold uniformity value and a predefined threshold randomness value. The method may further include modifying, by the postprocessing unit, one or more of the plurality of QRNs based on the uniformity value and the randomness value using an autocorrection algorithm to obtain a target uniformity value and a target randomness value.

In one embodiment, a system for autocorrecting Quantum Random Numbers (QRNs) generation may be disclosed. In one example, the system may include a processor and a computer-readable medium communicatively coupled to the processor. The computer-readable medium may store processor-executable instructions, which, on execution, may cause the processor to receive, by a postprocessing unit, a plurality of QRNs from a cloud-based quantum computer. Each of the plurality of QRNs may include one or more digits. The processor-executable instructions, on execution, may further cause the processor to calculate, by the postprocessing unit, a uniformity value and a randomness value corresponding to the one or more digits of the plurality of QRNs based on a predefined threshold uniformity value and a predefined threshold randomness value. The processor-executable instructions, on execution, may further cause the processor to modify, by the postprocessing unit, one or more of the plurality of QRNs based on the uniformity value and the randomness value using an autocorrection algorithm to obtain a target uniformity value and a target randomness value.

In one embodiment, a non-transitory computer-readable medium storing computer-executable instructions for autocorrecting Quantum Random Numbers (QRNs) generation may be disclosed. In one example, the stored instructions, when executed by a processor, may cause the processor to perform operations including receiving, by a postprocessing unit, a plurality of QRNs from a cloud-based quantum computer. Each of the plurality of QRNs may include one or more digits. The operations may further include calculating, by the postprocessing unit, a uniformity value and a randomness value corresponding to the one or more digits of the plurality of QRNs based on a predefined threshold uniformity value and a predefined threshold randomness value. The operations may further include modifying, by the postprocessing unit, one or more of the plurality of QRNs based on the uniformity value and the randomness value using an autocorrection algorithm to obtain a target uniformity value and a target randomness value.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for autocorrecting Quantum Random Numbers (QRNs) generation, in accordance with some embodiments of the present disclosure.

FIG. 2 illustrates a flow diagram of an exemplary process for autocorrecting Quantum Random Numbers (QRNs) generation, in accordance with some embodiments of the present disclosure.

FIG. 3 is a graphical comparison of 1 million random bits generated from a Pseudo Random Number Generator (PRNG) and Quantum random Number Generator (QRNG), in accordance with an embodiment of the present disclosure.

FIG. 4 is a table providing a partial snapshot of results obtained from National Institute of Standards and Testing (NIST) test of generated random bits, in accordance with an embodiment of the present disclosure.

FIG. 5 is a table providing a partial snapshot of results obtained from Dieharder test of generated random bits, in accordance with an embodiment of the present disclosure.

FIG. 6 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

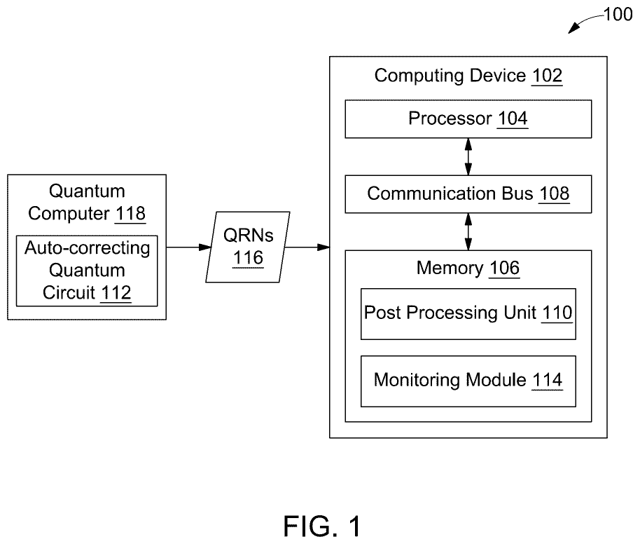

Referring now to FIG. 1, an exemplary system 100 for autocorrecting Quantum Random Numbers (QRNs) generation is illustrated, in accordance with some embodiments of the present disclosure. The system 100 may include a computing device 102 (for example, server, desktop, laptop, notebook, netbook, tablet, smartphone, mobile phone, or any other computing device), in accordance with some embodiments of the present disclosure. The computing device 102 may include a processor 104 and a memory 106. The processor 104 and the memory 106 may be communicatively coupled with each other through a communication bus 108. It should be noted that the processor 104 is representative an entire processing circuitry of the computing device 102 and may include more than one processor.

The memory 106 may store instructions that, when executed by the processor 104, cause the processor 104 to autocorrect QRNs generation, in accordance with aspects of the present disclosure. The memory 106 may also store various data (for example, a plurality of QRNs, uniformity values, randomness values, and the like) that may be captured, extracted, processed, and/or required by the system 100. The memory 106 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

Further, the memory 106 of the computing device 102 may include a postprocessing unit 110, and a monitoring module 114. The system 100 may further include a cloud-based quantum computer 118. A plurality of QRNs 116 may be generated through Qubits of the cloud-based quantum computer 118. The cloud-based quantum computer 118 may include an autocorrecting Quantum circuit 112. The autocorrecting Quantum circuit 112 may auto correct the plurality of QRNs 116 generated by the cloud-based quantum computer 118.

Each of the plurality of QRNs 116 may include one or more digits (for example, 0, 1, etc.). In an embodiment, each of the one or more digits may be one of 0 or 1. Further, the postprocessing unit 110 of the computing device 102 may receive the plurality of QRNs 116. The postprocessing unit 110 may calculate a uniformity value and a randomness value corresponding to the one or more digits of the plurality of QRNs 116 based on a predefined threshold uniformity value and a predefined threshold randomness value. The uniformity value and the randomness value may be in context of a digit (e.g., total frequency of 0 s and 1 s among the plurality of QRNs 116) or entire numbers (e.g., frequency of each QRN among the plurality of QRNs 116).

Further, the postprocessing unit 110 may modify one or more of the plurality of QRNs 116 based on the uniformity value and the randomness value using an autocorrection algorithm to obtain a target uniformity value and a target randomness value. For each QRN of the one or more of the plurality of QRNs 116 to be modified, the postprocessing unit 110 may change at least one digit of the QRN.

The monitoring module 114 may monitor in real-time, the uniformity value and the randomness value. In an embodiment, the monitoring module 114 may initiate calculation of the uniformity value and the randomness value via the postprocessing unit 110 upon receiving a predefined number of QRNs from the plurality of QRNs 116. The predefined number may be one or above. The monitoring module 114 may determine whether there is a statistical bias in the generated plurality of QRNs 116.

By way of an example, when a current uniformity value is below the target uniformity value, or when a current randomness value is below the target randomness value, the postprocessing unit 110 may change one or more QRNs to obtain the target uniformity value or the target randomness value. For example, if a QRN to be changed is 1000 and to obtain the monitoring module 114 determines a bias towards 0 digit, the changed QRN may be 1001 or 1011 or 1111 depending on the target uniformity value or the target randomness value. It should be noted that upon modifying, a discard rate of the plurality of QRNs is less than about 5%.

The system 100 may interact with a user via a user interface accessible via a display (not shown in figure). The system 100 may also include one or more external devices (not shown in figure). In some embodiments, the computing device 102 may interact with the one or more external devices over a communication network for sending or receiving various data. The external devices may include, but may not be limited to, a remote server, a digital device, or another computing system. Examples of the communication network may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and a combination thereof.

It should be noted that all such aforementioned modules 110-114 may be represented as a single module or a combination of different modules. Further, as will be appreciated by those skilled in the art, each of the modules 110-114 may reside, in whole or in parts, on one device or multiple devices in communication with each other. In some embodiments, each of the modules 110-114 may be implemented as dedicated hardware circuit comprising custom application-specific integrated circuit (ASIC) or gate arrays, off-the-shelf semiconductors such as logic chips, transistors, or other discrete components. Each of the modules 110-114 may also be implemented in a programmable hardware device such as a field programmable gate array (FPGA), programmable array logic, programmable logic device, and so forth. Alternatively, each of the modules 110-114 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for autocorrecting QRNs. For example, the exemplary system 100 and the associated computing device 102 may autocorrect QRNs by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

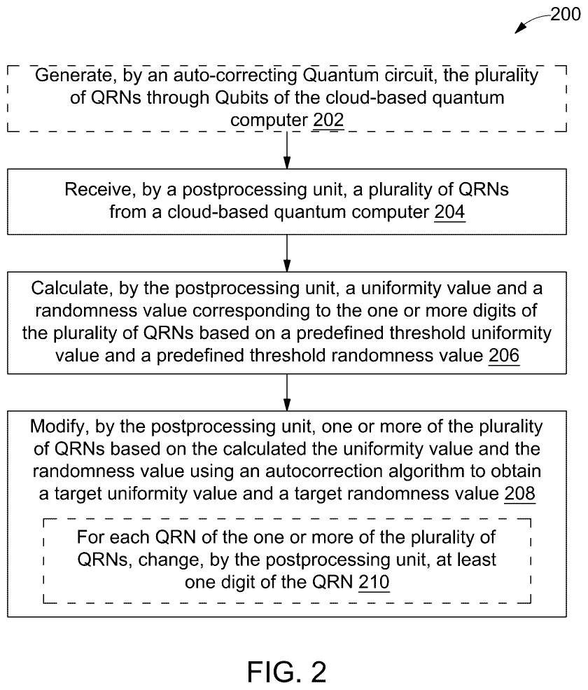

Referring now to FIG. 2, an exemplary process 200 for autocorrecting QRNs generation is depicted via a flowchart, in accordance with some embodiments of the present disclosure. The process 200 may be implemented by the computing device 102 of the system 100. The process 200 may include generating, via an auto-correcting Quantum circuit (such as the auto-correcting Quantum circuit 112), a plurality of QRNs through Qubits of a cloud-based quantum computer, at step 202. Further, the process 200 may include receiving, by the postprocessing unit (such as the postprocessing unit 110), the plurality of QRNs from the cloud-based quantum computer, at step 204. Each of the plurality of QRNs may include one or more digits. Each of the one or more digits may be one of 0 or 1.

Further, the process 200 may include calculating, by the postprocessing unit, a uniformity value and a randomness value corresponding to the one or more digits of the plurality of QRNs based on a predefined threshold uniformity value and a predefined threshold randomness value, at step 206. In some embodiments, the postprocessing unit may monitor in real-time, the uniformity value and the randomness value. To monitor the uniformity value and the randomness value, the postprocessing unit may calculate the uniformity value and the randomness value upon receiving a predefined number of QRNs from the plurality of QRNs. The predefined number is one or above. For example, the postprocessing unit may periodically calculate the uniformity value and the randomness value after receiving a predefined number of QRNs (such as 100, 200, 1000, etc.). Alternatively, the postprocessing unit may calculate the uniformity value and the randomness value after each new QRN is received.

Further, the process 200 may include modifying, by the postprocessing unit, one or more of the plurality of QRNs based on the calculated the uniformity value and the randomness value using an autocorrection algorithm to obtain a target uniformity value and a target randomness value, at step 208. The step 208 of the process 200 may include, for each QRN of the one or more of the plurality of QRNs, changing, by the postprocessing unit, at least one digit of the QRN, at step 210. It should be noted that upon modifying, a discard rate of the plurality of QRNs is less than about 5%.

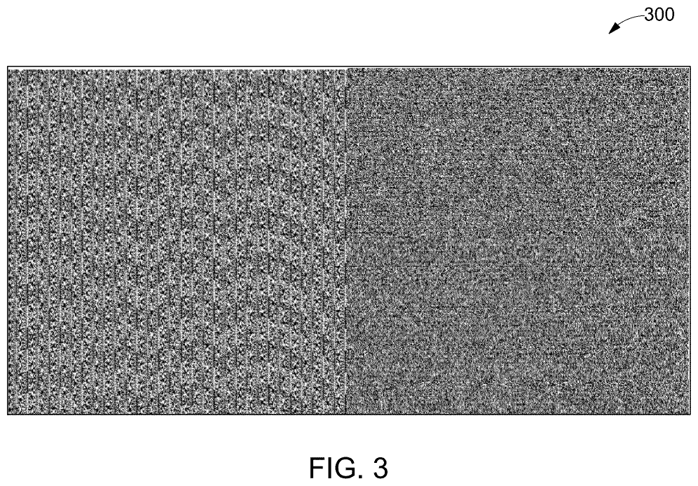

Referring now to FIG. 3, a graphical comparison of 1 million random bits (i.e., QRNs) generated from a Pseudo Random Number Generator (PRNG) and Quantum random Number Generator (QRNG) is shown, in accordance with some embodiments of the present disclosure. Graph 300A represents 1 million (1000×1000) random bits generated from a PRNG. Graph 300B represents 1 million (1000×1000) random bits generated from a QRNG using a system (like the system 100). It is clearly visible that quantum random numbers (represented by the graph 300B) are not following pattern like pseudo random numbers (represented by the graph 300A).

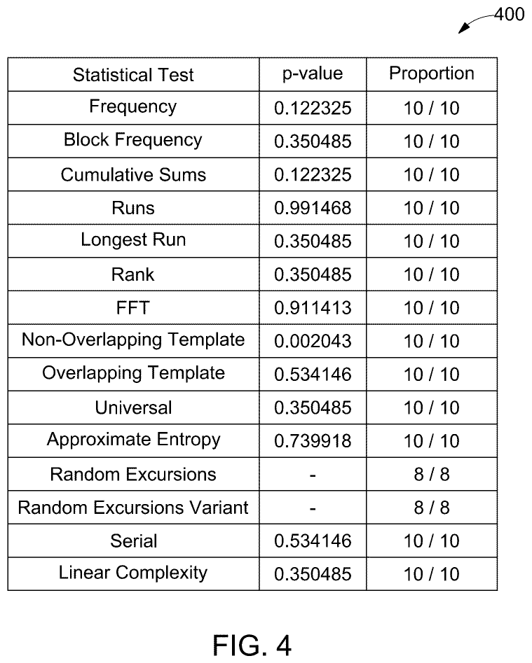

Referring now to FIG. 4, a table 400 providing a partial snapshot of results obtained from National Institute of Standards and Testing (NIST) test of generated random bits (i.e., QRNs) is shown, in accordance with some embodiments of the present disclosure. During the design, security evaluation, and certification process, the principle of random number generator and its implementation are evaluated statistically using standard statistical test suites like National Institute of Standards and Testing (NIST) SP 800-22, and Dieharder. The NIST test conducted results given in the table 400 are of NIST test suite 800-22A. The table 400 may include p-values and proportions corresponding to various statistical tests such as, but not limited to, frequency, block frequency, cumulative sums, runs, longest run, rank, FFT, non-overlapping template, overlapping template, universal, approximate entropy, random excursions, random excursions variant, serial, linear complexity, and the like. It should be noted that each of the statistical tests in the table 400 have been performed on 10 million bits (i.e., QRNs).

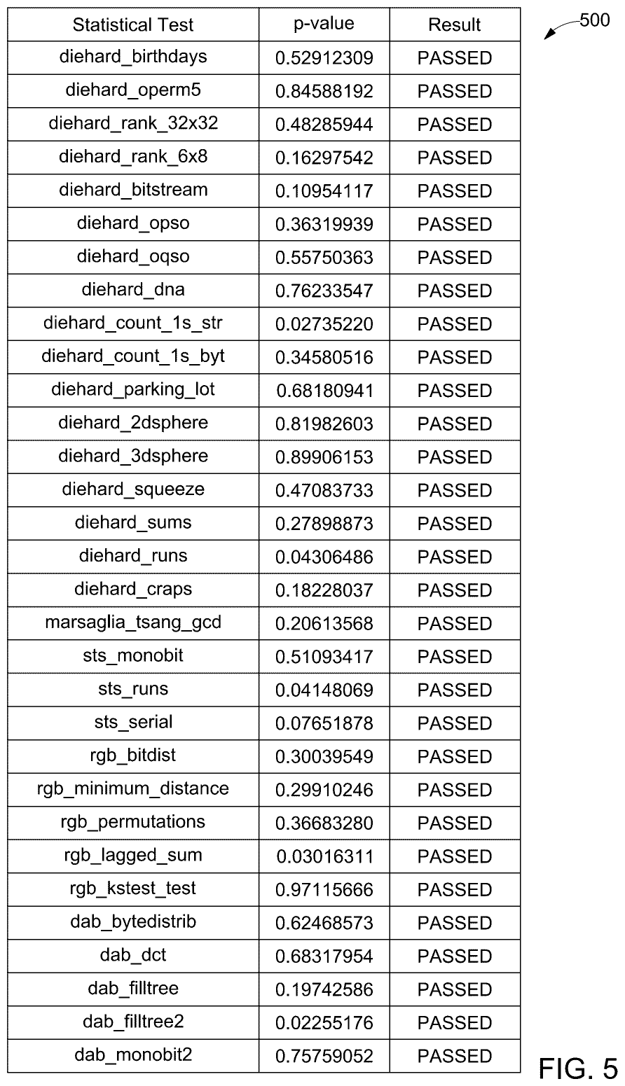

Referring now to FIG. 5, a table 500 providing a partial snapshot of results obtained from Dieharder test of generated random bits (i.e., QRNs) is shown, in accordance with some embodiments of the present disclosure. The table 500 may include p-values and results (PASSED or FAILED) corresponding to various statistical tests such as, but not limited to, diehard_birthdays, diehard_operm5, diehard_rank_32×32, diehard_rank_6×8, diehard_bitstream, diehard_opso, diehard_oqso, diehard_dna, diehard_count_1s_str, diehard_count_1s_byt, diehard_parking_lot, diehard_2dsphere, diehard_3dsphere, diehard_squeeze, diehard_sums, diehard_runs, diehard_craps, marsaglia_tsang_gcd, sts_monobit, sts_runs, sts_serial, rgb_bitdist, rgb_minimum_distance, rgb_permutations, rgb_lagged_sum, rgb_kstest_test, dab_bytedistrib, dab_dct, dab_filltree, dab_filltree2, dab_monobit2, and the like. It should be noted that each of the statistical tests in the table 500 have been performed on 10 million bits (i.e., QRNs).

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

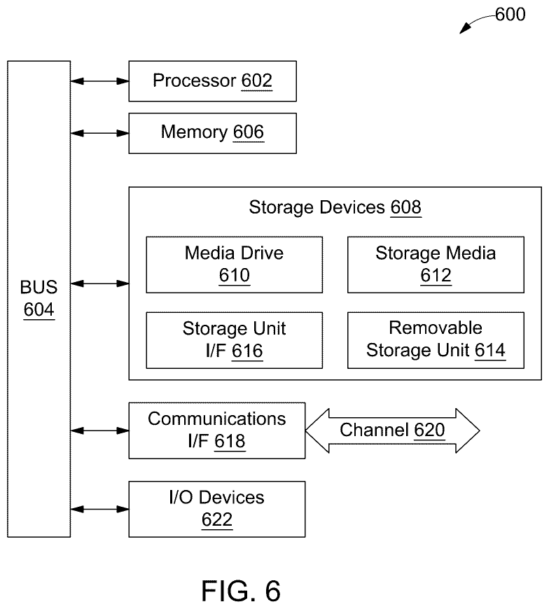

The disclosed methods and systems may be implemented on a conventional or a general-purpose computer system, such as a personal computer (PC) or server computer. Referring now to FIG. 6, an exemplary computing system 600 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 600 may represent, for example, a user device such as a desktop, a laptop, a mobile phone, personal entertainment device, DVR, and so on, or any other type of special or general-purpose computing device as may be desirable or appropriate for a given application or environment. The computing system 600 may include one or more processors, such as a processor 602 that may be implemented using a general or special purpose processing engine such as, for example, a microprocessor, microcontroller or other control logic. In this example, the processor 602 is connected to a bus 604 or other communication medium. In some embodiments, the processor 602 may be an Artificial Intelligence (AI) processor, which may be implemented as a Tensor Processing Unit (TPU), or a graphical processor unit, or a custom programmable solution Field-Programmable Gate Array (FPGA).

The computing system 600 may also include a memory 606 (main memory), for example, Random Access Memory (RAM) or other dynamic memory, for storing information and instructions to be executed by the processor 602. The memory 606 also may be used for storing temporary variables or other intermediate information during execution of instructions to be executed by the processor 602. The computing system 600 may likewise include a read only memory (“ROM”) or other static storage device coupled to bus 604 for storing static information and instructions for the processor 602.

The computing system 600 may also include a storage devices 608, which may include, for example, a media drive 610 and a removable storage interface. The media drive 610 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 612 may include, for example, a hard disk, magnetic tape, flash drive, or other fixed or removable medium that is read by and written to by the media drive 610. As these examples illustrate, the storage media 612 may include a computer-readable storage medium having stored therein particular computer software or data.

In alternative embodiments, the storage devices 608 may include other similar instrumentalities for allowing computer programs or other instructions or data to be loaded into the computing system 600. Such instrumentalities may include, for example, a removable storage unit 614 and a storage unit interface 616, such as a program cartridge and cartridge interface, a removable memory (for example, a flash memory or other removable memory module) and memory slot, and other removable storage units and interfaces that allow software and data to be transferred from the removable storage unit 614 to the computing system 600.

The computing system 600 may also include a communications interface 618. The communications interface 618 may be used to allow software and data to be transferred between the computing system 600 and external devices. Examples of the communications interface 618 may include a network interface (such as an Ethernet or other NIC card), a communications port (such as for example, a USB port, a micro USB port), Near field Communication (NFC), etc. Software and data transferred via the communications interface 618 are in the form of signals which may be electronic, electromagnetic, optical, or other signals capable of being received by the communications interface 618. These signals are provided to the communications interface 618 via a channel 620. The channel 620 may carry signals and may be implemented using a wireless medium, wire or cable, fiber optics, or other communications medium. Some examples of the channel 620 may include a phone line, a cellular phone link, an RF link, a Bluetooth link, a network interface, a local or wide area network, and other communications channels.

The computing system 600 may further include Input/Output (I/O) devices 622. Examples may include, but are not limited to a display, keypad, microphone, audio speakers, vibrating motor, LED lights, etc. The I/O devices 622 may receive input from a user and also display an output of the computation performed by the processor 602. In this document, the terms “computer program product” and “computer-readable medium” may be used generally to refer to media such as, for example, the memory 606, the storage devices 608, the removable storage unit 614, or signal(s) on the channel 620. These and other forms of computer-readable media may be involved in providing one or more sequences of one or more instructions to the processor 602 for execution. Such instructions, generally referred to as “computer program code” (which may be grouped in the form of computer programs or other groupings), when executed, enable the computing system 600 to perform features or functions of embodiments of the present invention.

In an embodiment where the elements are implemented using software, the software may be stored in a computer-readable medium and loaded into the computing system 600 using, for example, the removable storage unit 614, the media drive 610 or the communications interface 618. The control logic (in this example, software instructions or computer program code), when executed by the processor 602, causes the processor 602 to perform the functions of the invention as described herein.

Various embodiments provide method and system for autocorrecting Quantum Random Numbers (QRNs). The disclosed method and system may receive, by an auto-correcting Quantum circuit, a plurality of QRNs from a cloud-based quantum computer. Each of the plurality of QRNs may include one or more digits.

Further, the method and system may calculate, by a postprocessing unit, a uniformity value and a randomness value corresponding to the one or more digits of the plurality of QRNs based on a predefined threshold uniformity value and a predefined threshold randomness value. Further, the method and system may modify, by the postprocessing unit, one or more of the plurality of QRNs based on the uniformity value and the randomness value using an autocorrection algorithm to obtain a target uniformity value and a target randomness value.

Thus, the techniques described in the present disclosure try to overcome the technical problem of autocorrecting Quantum Random Numbers (QRNs). Development of less noisy quantum hardware is still in its nascency if scaling and full-scale commercialization factors are considered. Though the process of initial random bit generation from quantum hardware directly is exponentially fast, the random bits cannot exhibit uniformity and unbiasedness due to inherent errors in them. As a result, the techniques of the present disclosure introduce a post-processing circuit which works on an auto-correction principle. The discard rate of the plurality of QRNs generated through the disclosed techniques is less than 5%.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for autocorrecting Quantum Random Numbers (QRNs). The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for autocorrecting Quantum Random Numbers (QRNs) generation, the method comprising:
receiving, by a postprocessing unit, a plurality of QRNs from a cloud-based quantum computer, wherein each of the plurality of QRNs comprises one or more digits;
calculating, by the postprocessing unit, a uniformity value and a randomness value corresponding to the one or more digits of the plurality of QRNs based on a predefined threshold uniformity value and a predefined threshold randomness value; and
modifying, by the postprocessing unit, one or more of the plurality of QRNs based on the uniformity value and the randomness value using an autocorrection algorithm to obtain a target uniformity value and a target randomness value.

2. The method of claim 1, further comprising generating, by an auto-correcting Quantum circuit, the plurality of QRNs through Qubits of the cloud-based quantum computer.

3. The method of claim 1, further comprising monitoring in real-time, by the postprocessing unit, the uniformity value and the randomness value.

4. The method of claim 3, wherein monitoring in real-time, the uniformity value comprises calculating, by the postprocessing unit, the uniformity value and the randomness value upon receiving a predefined number of QRNs from the plurality of QRNs, wherein the predefined number is one or above.

5. The method of claim 1, wherein each of the one or more digits is one of 0 or 1.

6. The method of claim 5, wherein modifying one or more of the plurality of QRNs comprises:
for each QRN of the one or more of the plurality of QRNs, changing, by the postprocessing unit, at least one digit of the QRN.

7. The method of claim 1, wherein, upon modifying, a discard rate of the plurality of QRNs is less than about 5%.

8. A system for autocorrecting Quantum Random Numbers (QRNs), the system comprising:
a processor; and
a memory communicatively coupled to the processor, wherein the memory stores processor instructions, which when executed by the processor, cause the processor to:
receive, by a postprocessing unit, a plurality of QRNs from a cloud-based quantum computer, wherein each of the plurality of QRNs comprises one or more digits;
calculate, by the postprocessing unit, a uniformity value and a randomness value corresponding to the one or more digits of the plurality of QRNs based on a predefined threshold uniformity value and a predefined threshold randomness value; and
modify, by the postprocessing unit, one or more of the plurality of QRNs based on the uniformity value and the randomness value using an autocorrection algorithm to obtain a target uniformity value and a target randomness value.

9. The system of claim 8, wherein the processor instructions, on execution, further cause the processor to generate, by an auto-correcting Quantum circuit, the plurality of QRNs through Qubits of the cloud-based quantum computer.

10. The system of claim 8, wherein the processor instructions, on execution, further cause the processor to monitor in real-time, by the postprocessing unit, the uniformity value and the randomness value.

11. The system of claim 10, wherein to monitor in real-time, the uniformity value, the processor instructions, on execution, cause the processor to calculate, by the postprocessing unit, the uniformity value and the randomness value upon receiving a predefined number of QRNs from the plurality of QRNs, wherein the predefined number is one or above.

12. The system of claim 8, wherein each of the one or more digits is one of 0 or 1.

13. The system of claim 12, wherein to modify one or more of the plurality of QRNs, the processor instructions, on execution, cause the processor to:
for each QRN of the one or more of the plurality of QRNs, change, by the postprocessing unit, at least one digit of the QRN.

14. The system of claim 8, wherein, upon modifying, a discard rate of the plurality of QRNs is less than about 5%.

15. A non-transitory computer-readable medium storing computer-executable instructions for autocorrecting Quantum Random Numbers (QRNs), the computer-executable instructions configured for:
receiving, by a postprocessing unit, a plurality of QRNs from a cloud-based quantum computer, wherein each of the plurality of QRNs comprises one or more digits;
calculating, by the postprocessing unit, a uniformity value and a randomness value corresponding to the one or more digits of the plurality of QRNs based on a predefined threshold uniformity value and a predefined threshold randomness value; and
modifying, by the postprocessing unit, one or more of the plurality of QRNs based on the uniformity value and the randomness value using an autocorrection algorithm to obtain a target uniformity value and a target randomness value.

16. The non-transitory computer-readable medium of claim 15, wherein the computer-executable instructions are further configured for generating, by an auto-correcting Quantum circuit, the plurality of QRNs through Qubits of the cloud-based quantum computer.

17. The non-transitory computer-readable medium of claim 15, wherein the computer-executable instructions are further configured for monitoring in real-time, by the postprocessing unit, the uniformity value and the randomness value.

18. The non-transitory computer-readable medium of claim 17, wherein for monitoring in real-time, the uniformity value, the computer-executable instructions are configured for calculating the uniformity value and the randomness value upon receiving a predefined number of QRNs from the plurality of QRNs, wherein the predefined number is one or above.

19. The non-transitory computer-readable medium of claim 15, wherein each of the one or more digits is one of 0 or 1.

20. The non-transitory computer-readable medium of claim 19, wherein for modifying one or more of the plurality of QRNs, the computer-executable instructions are configured for:
for each QRN of the one or more of the plurality of QRNs, changing, by the postprocessing unit, at least one digit of the QRN.
